(19) United States
(12) Patent Application Publication
(10) Pub. No.: US 2014/0005893 A1
(43) Pub. Date: Jan. 2, 2014

(54) DRIVING CONTROL APPARATUS OF VEHICLE AND DRIVING CONTROL METHOD THEREOF

(71) Applicant: Man Bok Park, Seoul (KR)

(72) Inventor: Man Bok Park, Seoul (KR)

(21) Appl. No.: 13/920,072

(22) Filed: Jun. 17, 2013

(30) Foreign Application Priority Data
Jun. 29, 2012 (KR) 10-2012-0070821

(51) Int. Cl. B60W 30/02; B60W 10/18; B60W 10/20; B60W 10/06

(52) U.S. Cl. CPC B60W 30/025; B60W 10/06; B60W 10/18; B60W 10/20; B60W 2600/00
USPC 701/41

(57) ABSTRACT

Disclosed is a driving control apparatus of a vehicle, which includes an eccentric braking unit to implement eccentric braking for change of a heading angle while the vehicle is being driven, and an engine torque controller to control engine torque so as to adjust current speed and yaw rate of the vehicle to preset speed and yaw rate when the eccentric braking unit changes the heading angle. In addition, a driving control method of a vehicle, includes implementing eccentric braking for change of a heading angle via the eccentric braking unit while the vehicle is being driven, and controlling engine torque via the engine torque controller so as to adjust current speed and yaw rate of the vehicle to preset reference speed and yaw rate when the eccentric braking unit changes the heading angle.

### CROSS-REFERENCE TO RELATED APPLICATION

This application claims the benefit of Korean Patent Application No. 2012-0070821, filed on Jun. 29, 2012 in the Korean Intellectual Property Office, the disclosure of which is incorporated herein by reference.

### BACKGROUND

1. Field

Embodiments of the present invention relate to a driving control apparatus of a vehicle and a driving control method thereof.

2. Description of the Related Art

General vehicles may be controlled by steering in the course of driving. Difficulty in steering may limit driving speed control and yaw rate control of a vehicle.

Therefore, conventional vehicles are limited in terms of speed due to deterioration in ride quality when driving at high speeds.

In recent years, a great deal of research has focused upon enabling safe driving at high speeds as well as improved ride comfort at high speeds through active driving speed control and yaw rate control.

### SUMMARY

It is one aspect of the present invention to provide a driving control apparatus of a vehicle and a driving control method thereof, which may ensure driving speed control as well as ride comfort at high speeds.

It is another aspect of the present invention to provide a driving control apparatus of a vehicle and a driving control method thereof, which may achieve safe driving as well as improved ride comfort.

Additional aspects of the invention will be set forth in part in the description which follows and, in part, will be obvious from the description, or may be learned by practice of the invention.

In accordance with one aspect of the invention, a driving control apparatus of a vehicle, includes an eccentric braking unit to perform eccentric braking for change of a heading angle while the vehicle is being driven, and an engine torque controller to control engine torque so as to adjust current speed and yaw rate of the vehicle to preset reference speed and yaw rate when the eccentric braking unit changes the heading angle.

The driving control apparatus may further include a steering controller to control steering of the vehicle so as to more accurately control the current yaw rate when the eccentric braking unit changes the heading angle.

The driving control apparatus may further include a first identification unit synchronized with the eccentric braking unit to enable identification of a current heading angle control situation when the eccentric braking unit changes the heading angle.

The driving control apparatus may further include a second identification unit synchronized with the engine torque controller to enable identification of a current engine torque control situation when the engine torque controller controls the engine torque.

The driving control apparatus may further include a third identification unit synchronized with the steering controller to enable identification of a current steering control situation when the steering controller controls steering of the vehicle.

In accordance with another aspect of the invention, a driving control method of a vehicle, includes implementing eccentric braking for change of a heading angle via an eccentric braking unit while the vehicle is being driven, and controlling engine torque via an engine torque controller so as to adjust current speed and yaw rate of the vehicle to preset reference speed and yaw rate when the eccentric braking unit changes the heading angle.

The driving control method may further include, after control of the engine torque, controlling steering of the vehicle via a steering controller so as to more accurately control the current yaw rate when the eccentric braking unit changes the heading angle.

The driving control method may further include, after implementation of eccentric braking, enabling identification of a current heading angle control situation via a first identification unit synchronized with the eccentric braking unit when the eccentric braking unit changes the heading angle.

The driving control method may further include, after control of the engine torque, enabling identification of a current engine torque control situation via a second identification unit synchronized with the engine torque controller when the engine torque controller controls the engine torque.

The driving control method may further include, after control of steering of the vehicle, enabling identification of a current steering control situation via a third identification unit synchronized with the steering controller when the steering controller controls steering of the vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram showing a configuration of a driving control apparatus of a vehicle according to a first embodiment of the present invention;

FIG. 2 is a view showing the concept of torque vectoring for heading angle control;

FIG. 3 is a graph showing prevention of speed reduction via torque vectoring based on activation/deactivation of an eccentric braking unit and an engine torque controller shown in FIG. 1;

FIG. 4 is a graph showing yaw rate control via torque vectoring based on activation/deactivation of the eccentric braking unit and the engine torque controller shown in FIG. 1;

FIG. 5 is a flowchart showing a driving control method of a vehicle according to the first embodiment of the present invention;

FIG. 6 is a block diagram showing a configuration of a driving control apparatus of a vehicle according to a second embodiment of the present invention;

FIG. 7 is a flowchart showing a driving control method of a vehicle according to the second embodiment of the present invention;

FIG. 8 is a block diagram showing a configuration of a driving control apparatus of a vehicle according to a third embodiment of the present invention;

FIG. 9 is a flowchart showing a driving control method of a vehicle according to the third embodiment of the present invention;

FIG. 10 is a block diagram showing a configuration of a driving control apparatus of a vehicle according to a fourth embodiment of the present invention;

FIG. 11 is a flowchart showing a driving control method of a vehicle according to the fourth embodiment of the present invention;

FIG. 12 is a block diagram showing a configuration of a driving control apparatus of a vehicle according to a fifth embodiment of the present invention; and

FIG. 13 is a flowchart showing a driving control method of a vehicle according to the fifth embodiment of the present invention.

### DETAILED DESCRIPTION

Hereinafter, the embodiments of the present invention will be described in detail with reference to the accompanying drawings.

### First Embodiment

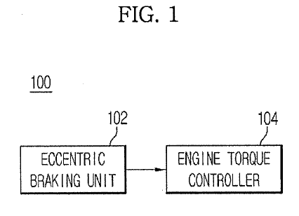

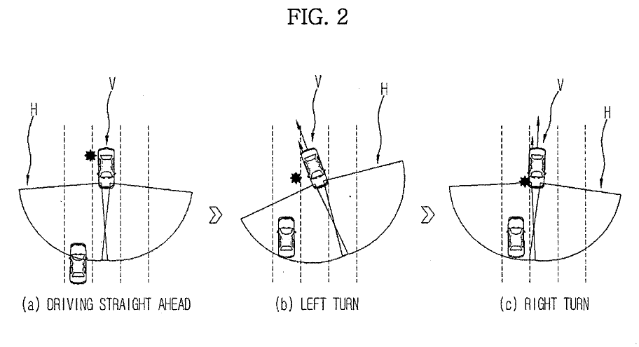

FIG. 1 is a block diagram showing a configuration of a driving control apparatus of a vehicle according to a first embodiment of the present invention, and FIG. 2 is a view showing the concept of torque vectoring for heading angle control.

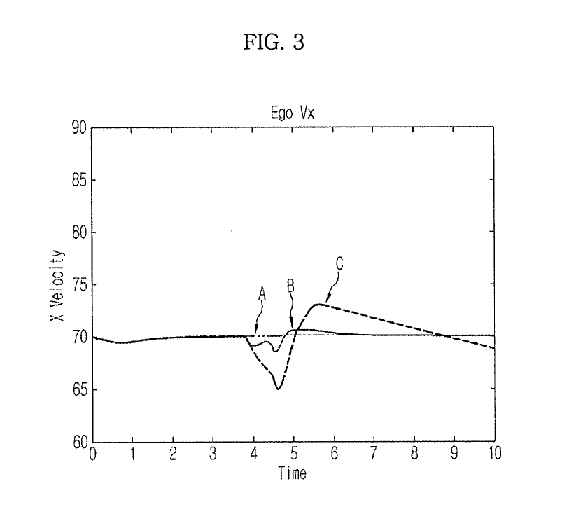

FIG. 3 is a graph showing prevention of speed reduction via torque vectoring based on activation/deactivation of an eccentric braking unit and an engine torque controller shown in FIG. 1.

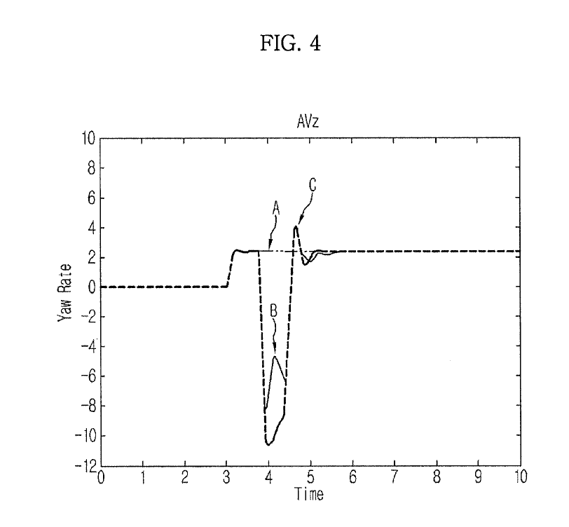

FIG. 4 is a graph showing yaw rate control via torque vectoring based on activation/deactivation of the eccentric braking unit and the engine torque controller shown in FIG. 1.

Referring to FIGS. 1 to 4, the driving control apparatus of a vehicle, designated by reference numeral 100, according to the first embodiment of the present invention includes an eccentric braking unit 102 and an engine torque controller 104.

As exemplarily shown in FIGS. 1 and 2, the eccentric braking unit 102 performs eccentric braking to change a heading angle H while a vehicle V is being driven.

The engine torque controller 104 controls engine torque to adjust current speed and yaw rate of the vehicle V to preset reference speed and yaw rate when the eccentric braking unit 102 changes the heading angle H.

In this case, the engine torque controller 104 may perform engine torque increase control to prevent speed reduction of the vehicle V and to achieve more accurate control of yaw rate.

The eccentric braking unit 102 and the engine torque controller 104, as mentioned above, realize torque vectoring as torque generated by a differential gear is applied to a wheel to which no braking force is applied.

In this case, as exemplarily shown in FIGS. 3 and 4, by comparing the case in which both the eccentric braking unit 102 and the engine torque controller 104 are deactivated (A), the case in which only the eccentric braking unit 102 is activated (B), and the case in which both the eccentric braking unit 102 and the engine torque controller 104 are activated (C) with one another, it will be understood that torque vectoring due to eccentric braking and engine torque control contributes to enhanced driving at high speeds and improved yaw rate.

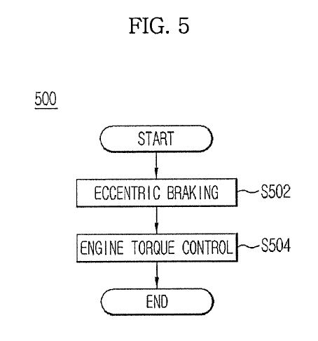

A driving control method of a vehicle using the driving control apparatus 100 according to the first embodiment of the present invention will be described hereinafter with reference to FIG. 5.

FIG. 5 is a flowchart showing a driving control method of a vehicle according to the first embodiment of the present invention.

Referring to FIG. 5, the driving control method, designated by reference numeral 500, according to the first embodiment of the present invention implements eccentric braking S502 and engine torque control S504.

In eccentric braking S502, while the vehicle (V of FIG. 2) is being driven, the eccentric braking unit (102 of FIG. 1) performs eccentric braking to change the heading angle (H of FIG. 2).

Thereafter, in engine torque S504, when the eccentric braking unit (102 of FIG. 1) changes the heading angle (H of FIG. 2), the engine torque controller (104 of FIG. 1) controls engine torque to adjust current speed and yaw rate of the vehicle (V of FIG. 2) to preset reference speed and yaw rate.

Here, engine torque control S504 may be engine torque increase control performed by the engine torque controller (104 of FIG. 1) to achieve enhanced driving at high speeds and improved yaw rate.

Through eccentric braking S502 and engine torque control S504, the eccentric braking unit (102 of FIG. 1) and the engine torque controller (104 of FIG. 1) realize torque vectoring as a torque generated by a differential gear is applied to a wheel to which no braking force is applied.

The vehicle driving control apparatus 100 and the driving control method thereof 500 according to the first embodiment of the present invention employ the eccentric braking unit 102 and the engine torque controller 104.

Accordingly, the vehicle driving control apparatus 100 and the driving control method thereof 500 according to the first embodiment of the present invention may accomplish enhanced driving at high speeds and improved yaw rate owing to torque vectoring due to eccentric braking and engine torque control, which may result in safe driving at high speeds as well as improved ride comfort at high speeds.

### Second Embodiment

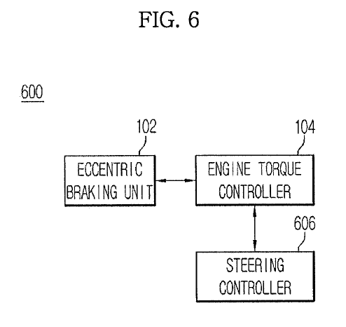

FIG. 6 is a block diagram showing a configuration of a driving control apparatus of a vehicle according to a second embodiment of the present invention.

Referring to FIG. 6, the driving control apparatus of a vehicle, designated by reference numeral 600, according to the second embodiment of the present invention includes the eccentric braking unit 102 and the engine torque controller 104, in the same manner as the driving control apparatus 100 according to the first embodiment.

Functions of the respective constituent elements of the vehicle driving control apparatus 600 according to the second embodiment of the present invention and connection relationships therebetween are identical to functions of the respective constituent elements of the vehicle driving control apparatus 100 according to the first embodiment. Therefore, repetitious explanation thereof will be omitted hereinafter.

The vehicle driving control apparatus 600 according to the second embodiment of the present invention further includes a steering controller 606.

The steering controller 606 controls steering of the vehicle (V of FIG. 2) to more accurately control current yaw rate when the eccentric braking unit 102 changes the heading angle (H of FIG. 2).

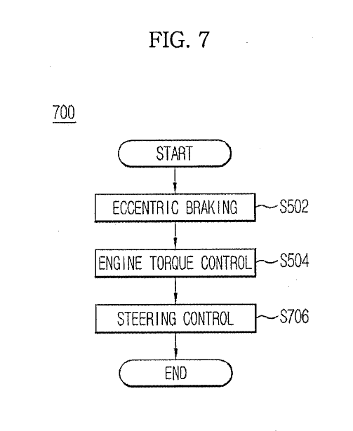

A driving control method of a vehicle using the driving control apparatus 600 according to the second embodiment of the present invention will be described hereinafter with reference to FIG. 7.

FIG. 7 is a flowchart showing a driving control method of a vehicle according to the second embodiment of the present invention.

Referring to FIG. 7, the driving control method, designated by reference numeral 700, according to the second embodiment of the present invention implements eccentric braking S502, engine torque control S504, and steering control S706 in this sequence.

First, in eccentric braking S502, while the vehicle (V of FIG. 2) is being driven, the eccentric braking unit (102 of FIG. 1) performs eccentric braking to change the heading angle (H of FIG. 2).

Thereafter, in engine torque control S504, when the eccentric braking unit (102 of FIG. 1) changes the heading angle (H of FIG. 2), the engine torque controller (104 of FIG. 1) controls engine torque to adjust current speed and yaw rate of the vehicle (V of FIG. 2) to preset reference speed and yaw rate.

Here, engine torque control S504 may be engine torque increase control performed by the engine torque controller (104 of FIG. 6) to achieve enhanced driving at high speeds and improved yaw rate.

Through eccentric braking S502 and engine torque control S504, the eccentric braking unit (102 of FIG. 6) and the engine torque controller (104 of FIG. 6) realize torque vectoring as torque generated by a differential gear is applied to a wheel to which no braking force is applied.

Finally, in steering control S706, the steering controller (606 of FIG. 6) controls steering of the vehicle (V of FIG. 2) to more accurately control current yaw rate when the eccentric braking unit (102 of FIG. 1) changes the heading angle (H of FIG. 2).

The vehicle driving control apparatus 600 and the driving control method thereof 700 thereof according to the second embodiment of the present invention employ the eccentric braking unit 102, the engine torque controller 104, and the steering controller 106.

Accordingly, the vehicle driving control apparatus 600 and the driving control method thereof 700 thereof according to the second embodiment of the present invention may accomplish additionally enhanced driving at high speeds and improved yaw rate owing to torque vectoring due to eccentric braking and engine torque control, which may result in safe driving at high speeds as well as improved ride comfort at high speeds.

### Third Embodiment

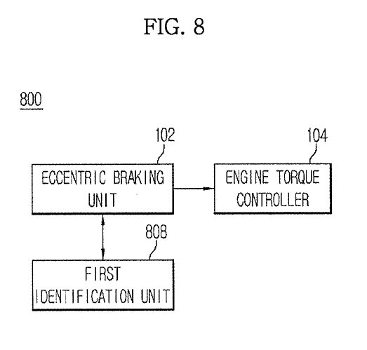

FIG. 8 is a block diagram showing a configuration of a driving control apparatus of a vehicle according to a third embodiment of the present invention.

Referring to FIG. 8, the driving control apparatus of a vehicle, designated by reference numeral 800, according to the third embodiment of the present invention includes the eccentric braking unit 102 and the engine torque controller 104, in the same manner as the driving control apparatus 100 according to the first embodiment.

Functions of the respective constituent elements of the vehicle driving control apparatus 800 according to the third embodiment of the present invention and connection relationships therebetween are identical to functions of the respective constituent elements of the vehicle driving control apparatus 100 according to the first embodiment. Therefore, repetitious explanation thereof will be omitted hereinafter.

The vehicle driving control apparatus 800 according to the third embodiment of the present invention further includes a first identification unit 808.

The first identification unit 808 is synchronized with the eccentric braking unit 102 to enable identification of a current heading angle control situation when the eccentric braking unit 102 changes the heading angle (H of FIG. 2).

In this case, although the first identification unit 808 is not shown in detail, a current heading angle control situation may be identified via at least one of speech notification through a speaker (not shown) provided at one side of the vehicle (V of FIG. 2) and light emission through a light emitting member (not shown) provided at the other side of the vehicle (V of FIG. 2).

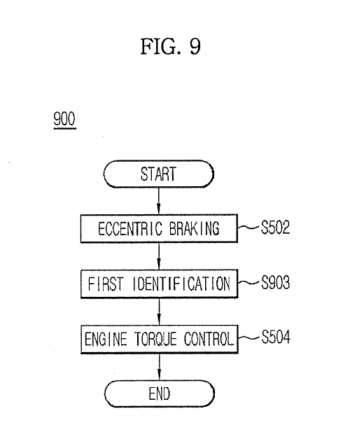

A driving control method of a vehicle using the driving control apparatus 800 according to the third embodiment of the present invention will be described hereinafter with reference to FIG. 9.

FIG. 9 is a flowchart showing a driving control method of a vehicle according to the third embodiment of the present invention.

Referring to FIG. 9, the vehicle driving control method, designated by reference numeral 900, according to the third embodiment of the present invention implements eccentric braking S502, first identification S903, and engine torque control S504 in this sequence.

First, in eccentric braking S502, while the vehicle (V of FIG. 2) is being driven, the eccentric braking unit (102 of FIG. 8) performs eccentric braking to change the heading angle (H of FIG. 2).

Thereafter, in first identification S903, the first identification unit (808 of FIG. 8) is synchronized with the eccentric braking unit (102 of FIG. 8) to enable identification of a current heading angle control situation when the eccentric braking unit (102 of FIG. 8) changes the heading angle (H of FIG. 2).

In first identification S903, although the first identification unit (808 of FIG. 8) is not shown, a current heading angle control situation may be identified via at least one of speech notification through a speaker (not shown) provided at one side of the vehicle (V of FIG. 2) and light emission through a light emitting member (not shown) provided at the other side of the vehicle (V of FIG. 2).

Finally, in engine torque control S504, when the eccentric braking unit (102 of FIG. 8) changes the heading angle (H of FIG. 2), the engine torque controller (104 of FIG. 8) controls engine torque to adjust current speed and yaw rate of the vehicle (V of FIG. 2) to preset reference speed and yaw rate.

Here, engine torque control S504 may be engine torque increase control performed by the engine torque controller (104 of FIG. 8) to achieve enhanced driving at high speeds and improved yaw rate.

Through eccentric braking S502 and engine torque control S504, the eccentric braking unit (102 of FIG. 8) and the engine torque controller (104 of FIG. 8) realize torque vectoring as torque generated by a differential gear is applied to a wheel to which no braking force is applied.

The vehicle driving control apparatus 800 and the driving control method thereof 900 thereof according to the third embodiment of the present invention employ the eccentric braking unit 102 and the engine torque controller 104.

Accordingly, the vehicle driving control apparatus 800 and the driving control method thereof 900 thereof according to the third embodiment of the present invention may accomplish enhanced driving at high speeds and improved yaw rate owing to torque vectoring due to eccentric braking and engine torque control, which may result in safe driving at high speeds as well as improved ride comfort at high speeds.

In addition, the vehicle driving control apparatus 800 and the driving control method thereof 900 thereof according to the third embodiment of the present invention includes the first identification unit 808.

Accordingly, the vehicle driving control apparatus 800 and the driving control method thereof 900 thereof according to the third embodiment of the present invention may assist a driver in identifying and recognizing a current heading angle control situation, which may result in safe driving at high speeds as well as improved ride comfort at high speeds.

### Fourth Embodiment

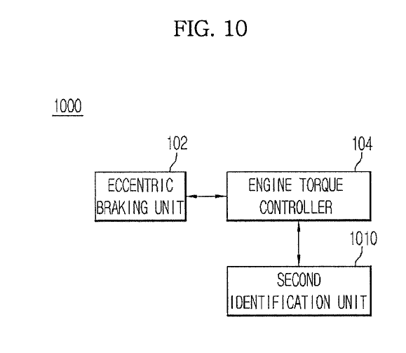

FIG. 10 is a block diagram showing a configuration of a driving control apparatus of a vehicle according to a fourth embodiment of the present invention.

Referring to FIG. 10, the driving control apparatus of a vehicle, designated by reference numeral 1000, according to the fourth embodiment of the present invention includes the eccentric braking unit 102 and the engine torque controller 104, in the same manner as the driving control apparatus 100 according to the first embodiment.

Functions of the respective constituent elements of the vehicle driving control apparatus 1000 according to the fourth embodiment of the present invention and connection relationships therebetween are identical to functions of the respective constituent elements of the vehicle driving control apparatus 100 according to the first embodiment. Therefore, repetitious explanation thereof will be omitted hereinafter.

The vehicle driving control apparatus 1000 according to the fourth embodiment of the present invention further includes a second identification unit 1010.

The second identification unit 1010 is synchronized with the engine torque controller 104 to enable identification of a current engine torque control situation when the engine torque controller 104 controls engine torque.

In this case, although the second identification unit 1010 is not shown in detail, a current engine torque control situation may be identified via at least one of speech notification through a speaker (not shown) provided at one side of the vehicle (V of FIG. 2) and light emission through a light emitting member (not shown) provided at the other side of the vehicle (V of FIG. 2).

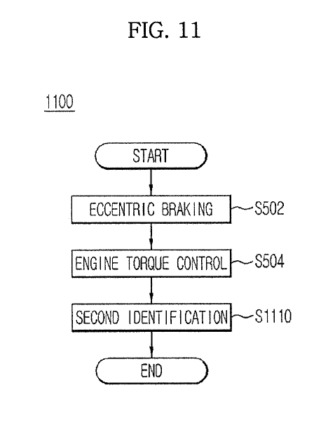

A driving control method of a vehicle using the driving control apparatus 1000 according to the fourth embodiment of the present invention will be described hereinafter with reference to FIG. 11.

FIG. 11 is a flowchart showing a driving control method of a vehicle according to the fourth embodiment of the present invention.

Referring to FIG. 11, the vehicular driving control method, designated by reference numeral 1100, according to the fourth embodiment of the present invention implements eccentric braking S502, engine torque control S504, and second identification S1110 in this sequence.

First, in eccentric braking S502, while the vehicle (V of FIG. 2) is being driven, the eccentric braking unit (102 of FIG. 10) performs eccentric braking to change the heading angle (H of FIG. 2).

Thereafter, in engine torque control S504, when the eccentric braking unit (102 of FIG. 10) changes the heading angle (H of FIG. 2), the engine torque controller (104 of FIG. 10) controls engine torque to adjust current speed and yaw rate of the vehicle (V of FIG. 2) to preset reference speed and yaw rate.

Here, engine torque control S504 may be engine torque increase control performed by the engine torque controller (104 of FIG. 10) to achieve enhanced driving at high speeds and improved yaw rate of the vehicle (V of FIG. 2).

Through eccentric braking S502 and engine torque control S504, the eccentric braking unit (102 of FIG. 10) and the engine torque controller (104 of FIG. 10) realize torque vectoring as torque generated by a differential gear is applied to a wheel to which no braking force is applied.

Finally, in second identification S1110, the second identification unit (1010 of FIG. 10) is synchronized with the engine torque controller (104 of FIG. 10) to enable identification of a current engine torque control situation when the engine torque controller (104 of FIG. 10) controls the engine torque.

In the second identification S1100, although the second identification unit 1010 is not shown in detail, a current engine torque control situation may be identified via at least one of speech notification through a speaker (not shown) provided at one side of the vehicle (V of FIG. 2) and light emission through a light emitting member (not shown) provided at the other side of the vehicle (V of FIG. 2).

The vehicle driving control apparatus 1000 and the driving control method thereof 1100 thereof according to the fourth embodiment of the present invention employ the eccentric braking unit 102 and the engine torque controller 104.

Accordingly, the vehicle driving control apparatus 1000 and the driving control method thereof 1100 thereof according to the fourth embodiment of the present invention may accomplish enhanced driving at high speeds and improved yaw rate owing to torque vectoring due to eccentric braking and engine torque control, which may result in safe driving at high speeds as well as improved ride comfort at high speeds.

In addition, the vehicle driving control apparatus 1000 and the driving control method thereof 1100 thereof according to the fourth embodiment of the present invention includes the second identification unit 1010.

Accordingly, the vehicle driving control apparatus 1000 and the driving control method thereof 1100 thereof according to the fourth embodiment of the present invention may assist the driver in identifying and recognizing a current engine torque control situation, which may result in safe driving at high speeds as well as improved ride comfort at high speeds.

### Fifth Embodiment

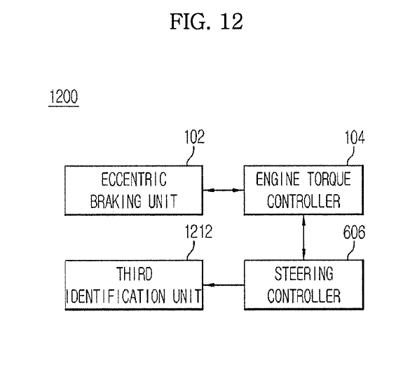

FIG. 12 is a block diagram showing a configuration of a driving control apparatus of a vehicle according to a fifth embodiment of the present invention.

Referring to FIG. 12, the driving control apparatus of a vehicle, designated by reference numeral 1200, according to the fifth embodiment of the present invention includes the eccentric braking unit 102, the engine torque controller 104, and the steering controller 606, in the same manner as the driving control apparatus 600 according to the second embodiment.

Functions of the respective constituent elements of the vehicle driving control apparatus 1200 according to the fifth embodiment of the present invention and connection relationships therebetween are identical to functions of the respective constituent elements of the vehicle driving control apparatus 600 according to the second embodiment. Therefore, repetitious explanation thereof will be omitted hereinafter.

The vehicle driving control apparatus 1200 according to the fifth embodiment of the present invention further includes a third identification unit 1212.

The third identification unit 1212 is synchronized with the steering controller 606 to enable identification of a current steering control situation when the steering controller 606 controls steering of the vehicle.

In this case, although the third identification unit 1212 is not shown in detail, a current steering control situation may be identified via at least one of speech notification through a speaker (not shown) provided at one side of the vehicle (V of FIG. 2) and light emission through a light emitting member (not shown) provided at the other side of the vehicle (V of FIG. 2).

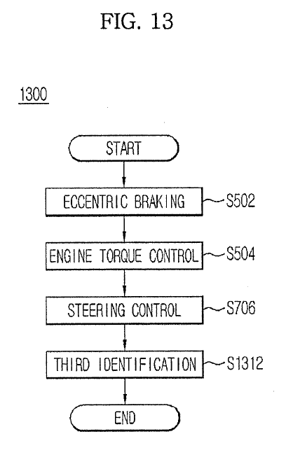

A driving control method of a vehicle using the driving control apparatus 1200 according to the fifth embodiment of the present invention will be described hereinafter with reference to FIG. 13.

FIG. 13 is a flowchart showing a driving control method of a vehicle according to the fifth embodiment of the present invention.

Referring to FIG. 13, the vehicular driving control method, designated by reference numeral 1300, according to the fifth embodiment of the present invention implements eccentric braking S502, engine torque control S504, steering control S706, and third identification S1312 in this sequence.

First, in eccentric braking S502, while the vehicle (V of FIG. 2) is being driven, the eccentric braking unit (102 of FIG. 12) performs eccentric braking to change the heading angle (H of FIG. 2).

Thereafter, in engine torque control S504, when the eccentric braking unit (102 of FIG. 12) changes the heading angle (H of FIG. 2), the engine torque controller (104 of FIG. 12) controls engine torque to adjust current speed and yaw rate of the vehicle (V of FIG. 2) to preset reference speed and yaw rate.

Here, engine torque control S504 may be engine torque increase control performed by the engine torque controller (104 of FIG. 12) to achieve enhanced driving at high speeds and to improved yaw rate of the vehicle (V of FIG. 2).

Through eccentric braking S502 and engine torque control S504, the eccentric braking unit (102 of FIG. 12) and the engine torque controller (104 of FIG. 12) realize torque vectoring as torque generated by a differential gear is applied to a wheel to which no braking force is applied.

Thereafter, in steering control S706, the steering controller (606 of FIG. 12) controls steering of the vehicle (V of FIG. 2) to more accurately control current yaw rate when the eccentric braking unit (102 of FIG. 12) changes the heading angle (H of FIG. 2).

Finally, in third identification S1312, the third identification unit (1212 of FIG. 12) is synchronized with the steering controller (606 of FIG. 12) to enable identification of a current steering control situation when the steering controller (606 of FIG. 12) controls steering of the vehicle.

In the third identification S1312, although the third identification unit 1212 is not shown in detail, a current steering control situation may be identified via at least one of speech notification through a speaker (not shown) provided at one side of the vehicle (V of FIG. 2) and light emission through a light emitting member (not shown) provided at the other side of the vehicle (V of FIG. 2).

The vehicle driving control apparatus 1200 and the driving control method thereof 1300 thereof according to the fifth embodiment of the present invention employ the eccentric braking unit 102, the engine torque controller 104, and the steering controller 606.

Accordingly, the vehicle driving control apparatus 1200 and the driving control method thereof 1300 according to the fifth embodiment of the present invention may accomplish enhanced driving at high speeds and improved yaw rate owing to torque vectoring due to eccentric braking and engine torque control, which may result in safe driving at high speeds as well as improved ride comfort at high speeds.

In addition, the vehicle driving control apparatus 1200 and the driving control method thereof 1300 according to the fifth embodiment of the present invention includes the third identification unit 1212.

Accordingly, the vehicle driving control apparatus 1200 and the driving control method thereof 1300 according to the fifth embodiment of the present invention may identify a current engine torque control situation to assist a driver in recognizing the current engine torque control situation, which may result in safe driving at high speeds as well as improved ride comfort at high speeds.

As is apparent from the above description, a vehicle driving control apparatus and a driving control method thereof according to embodiments of the present invention may achieve the following effects.

Firstly, it may be possible to achieve driving speed control of a vehicle as well as ride comfort at high speeds.

Secondly, it may be possible to achieve safe driving as well as improved ride comfort.

Although the embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A driving control apparatus of a vehicle, comprising:
an eccentric braking unit to perform eccentric braking for change of a heading angle while the vehicle is being driven; and
an engine torque controller to control engine torque so as to adjust current speed and yaw rate of the vehicle to preset reference speed and yaw rate when the eccentric braking unit changes the heading angle.

2. The apparatus according to claim 1, further comprising a steering controller to control steering of the vehicle so as to more accurately control the current yaw rate when the eccentric braking unit changes the heading angle.

3. The apparatus according to claim 1, further comprising a first identification unit synchronized with the eccentric braking unit to enable identification of a current heading angle control situation when the eccentric braking unit changes the heading angle.

4. The apparatus according to claim 1, further comprising a second identification unit synchronized with the engine torque controller to enable identification of a current engine torque control situation when the engine torque controller controls the engine torque.

5. The apparatus according to claim 2, further comprising a third identification unit synchronized with the steering controller to enable identification of a current steering control situation when the steering controller controls steering of the vehicle.

6. A driving control method of a vehicle, comprising:
implementing eccentric braking for change of a heading angle via an eccentric braking unit while the vehicle is being driven; and
controlling engine torque via an engine torque controller so as to adjust current speed and yaw rate of the vehicle to preset reference speed and yaw rate when the eccentric braking unit changes the heading angle.

7. The method according to claim 6, further comprising, after control of the engine torque, controlling steering of the vehicle via a steering controller so as to more accurately control the current yaw rate when the eccentric braking unit changes the heading angle.

8. The method according to claim 6, further comprising, after implementation of eccentric braking, enabling identification of a current heading angle control situation via a first identification unit synchronized with the eccentric braking unit when the eccentric braking unit changes the heading angle.

9. The method according to claim 6, further comprising, after control of the engine torque, enabling identification of a current engine torque control situation via a second identification unit synchronized with the engine torque controller when the engine torque controller controls the engine torque.

10. The method according to claim 7, further comprising, after control of steering of the vehicle, enabling identification of a current steering control situation via a third identification unit synchronized with the steering controller when the steering controller controls steering of the vehicle.
